(19) United States
(12) Patent Application Publication
(10) Pub. No.: US 2017/0328354 A1
(43) Pub. Date: Nov. 16, 2017

(54) RECIRCULATING GRADIENT POWER SYSTEM

(71) Applicant: IMUSHROOM DIGITAL LIMITED, Taoyuan (TW)

(72) Inventors: CHI-CHUNG LO, Taoyuan (TW); MING-HSIU LEE, Taoyuan (TW)

(21) Appl. No.: 15/499,992

(22) Filed: Apr. 28, 2017

(30) Foreign Application Priority Data
May 13, 2016 (CN) 201610317269.1

(51) Int. Cl. F03G 3/00; F15B 15/14; F15B 15/06

(52) U.S. Cl. CPC F03G 3/00; F15B 15/06; F15B 15/1409

(57) ABSTRACT

A recirculating gradient power system includes a motion carrier capable of changing its tilt orientation and tilt angle. The central vertical axis of the motion carrier is provided with a rotating shaft. The rotating shaft is pivotally connected with a counterweight. The counterweight is rotationally displaced from a high point of the motion carrier toward a lower point of the motion carrier about the rotating shaft by gravity. At least four power cylinders are evenly arranged at four diagonal corners around the periphery of the central vertical axis of the motion carrier to drive the motion carrier to change the tilt orientation and the tilt angle. A control module is connected with the power cylinders for controlling the operation of the power cylinders which are set in advance when the counterweight is rotationally displaced to a predetermined stroke.

### FIELD OF THE INVENTION

The present invention relates to a power output system, and more particularly to a recirculating gradient power system capable of producing a continuous and stable rotational motion by the output of intermittent fluid energy.

### BACKGROUND OF THE INVENTION

In order to solve energy problems, each country in the world is actively looking for alternative energy sources to contribute to the improvement of energy depletion, especially environmentally friendly pollution-free green energy. The most important technology is how to use natural energy sources, such as wind, water, geothermal and the like, for energy conversion through mechanical motion.

Moreover, the common types of mechanical motion mainly include rotary motion, linear motion, reciprocating motion and oscillating motion. The conversion and control of different mechanical motion are achieved through corresponding mechanisms. For example, the rotary motion can be converted into linear motion by means of a cam mechanism. The reciprocating motion can be converted into rotary motion by means of a crank slider mechanism.

It has been known that a high-speed or high-pressure fluid can be used to act on an impeller (such as water or wind wheel) to produce a continuous rotary power output. The rotary power is used to drive a generator to run, achieving the purpose of power generation. In general, the fluid is accumulated to a certain extent in advance to meet the needs of stable power generation.

However, the above-mentioned power output system or equipment provides a continuous rotary effect by means of the output of continuous uninterrupted fluid. That is, when the impeller is in an inertia motion state, there is still a lot of fluid kinetic energy loss. How to use the kinetic energy more efficiently has long been the topic that the industry and the academia want to solve.

Accordingly, the inventor of the present invention has devoted himself based on his many years of practical experiences to develop a circulating gradient power system which comprise a motion carrier, a rotating shaft, a counterweight, power cylinders, and a control module. Under the operation of the control module and all the power cylinders, the rotating shaft can be rotated continuously and stably by the output of intermittent fluid energy to achieve the purpose of using the kinetic energy more efficiently.

### SUMMARY OF THE INVENTION

The primary object of the present invention is to provide a recirculating gradient power system capable of capable of producing a continuous and stable rotational motion by the output of intermittent fluid energy.

In order to achieve the aforesaid object, the recirculating gradient power system of the present invention comprises a motion carrier, a rotating shaft, a counterweight, a plurality of power cylinders, and a control module. The motion carrier is horizontally arranged and has a central vertical axis as a pivot to change its tilt orientation and tilt angle. The rotating shaft is vertically disposed at the position of the central vertical axis of the motion carrier. The counterweight is pivotally connected to the rotating shaft through a coupling mechanism. The counterweight is rotationally displaced from a high point of the motion carrier toward a lower point of the motion carrier about the rotating shaft by gravity to rotate the rotating shaft synchronously. The power cylinders are evenly arranged at diagonal corners around the periphery of the central vertical axis of the motion carrier. Each of the power cylinders is provided with a push rod connected with a pressure source to drive the motion carrier to change the tilt orientation and the tilt angle. The control module is connected with the power cylinders for controlling the operation of the power cylinders which are set in advance when the counterweight is rotationally displaced to a predetermined stroke.

The recirculating gradient power system of the present invention allows the motion carrier to continuously rotate in the direction of displacement of the counterweight to change the tilt orientation by means of the fluid kinetic energy supplied from an air compressor or a hydraulic device connected with the power cylinders, under the operation of the control module and all the power cylinders. Normally, the counterweight is rotationally displaced from the high point of the motion carrier toward the lower point of the motion carrier by gravity. The rotating shaft can be rotated continuously and stably by the intermittent fluid energy output from the power cylinders, achieving the purpose of using the kinetic energy more efficiently.

According to the aforesaid technical feature, the counterweight is provided with at least one roller in contact with the motion carrier to roll on the motion carrier.

According to the aforesaid technical feature, the motion carrier is provided with an annular track, and the at least one roller of the counterweight is in contact with the track to roll on the track.

According to the aforesaid technical feature, the motion carrier is provided with an annular track. The at least one roller of the counterweight is in contact with the track to roll on the track. The counterweight is provided with at least two auxiliary rollers respectively corresponding to two sides of the track.

According to the aforesaid technical feature, the coupling mechanism includes an elbow member. Two ends of the elbow member are pivotally connected to the rotating shaft and the counterweight, respectively.

According to the aforesaid technical feature, the coupling mechanism is provided with a pivot member fixed to the counterweight. One end of the pivot member is formed with two arms corresponding to two sides of the rotating shaft. A pin is provided to penetrate the two arms and the rotating shaft.

According to the aforesaid technical feature, the coupling mechanism is provided with a first connecting member fixed to the counterweight. A second connecting member is mounted on the first connecting member and is telescopic relative to the first connecting member. One end of the second connecting member is provided with a pivot member. One end of the pivot member is formed with two arms corresponding to two sides of the rotating shaft. A pin is provided to penetrate the two arms and the rotating shaft.

According to the aforesaid technical feature, the counterweight is disposed at a position where the center of mass of the counterweight is located above the motion carrier. The counterweight is provided with four rollers in contact with the motion carrier to roll on the motion carrier. The coupling mechanism is provided with an elbow member. Two ends of the elbow member are pivotally connected to the rotating shaft and the counterweight, respectively.

According to the aforesaid technical feature, the counterweight is disposed at a position where the center of mass of the counterweight is located above the motion carrier. The at least one roller of the counterweight is in contact with the motion carrier to roll on the motion carrier. The roller has an arc surface. The coupling mechanism is provided with a pivot member fixed to the counterweight. One end of the pivot member is formed with two arms corresponding to two sides of the rotating shaft. A pin is provided to penetrate the two arms and the rotating shaft.

According to the aforesaid technical feature, the counterweight is disposed at a position where the center of mass of the counterweight is located at an outer side of the motion carrier. The motion carrier is provided with an annular track. The at least one roller of the counterweight is in contact with the track to roll on the track. The counterweight is provided with at least two auxiliary rollers respectively corresponding to two sides of the track. The roller has an arc surface. The coupling mechanism is provided with a first connecting member fixed to the counterweight. A second connecting member is mounted on the first connecting member and is telescopic relative to the first connecting member. One end of the second connecting member is provided with a pivot member. One end of the pivot member is formed with two arms corresponding to two sides of the rotating shaft. A pin is provided to penetrate the two arms and the rotating shaft. The first connecting member is provided with two first stoppers thereon. At least one guide post is provided between the two first stoppers. The second connecting member is provided with a first sliding seat inserted between the two first stoppers. The first sliding seat is provided with at least one guide hole for the guide post of the first connecting member to insert therethrough.

According to the aforesaid technical feature, the counterweight is disposed at a position where the center of mass of the counterweight is located at an outer side of the motion carrier. The motion carrier is provided with an annular track. The at least one roller of the counterweight is in contact with the track to roll on the track. The counterweight is provided with at least two auxiliary rollers respectively corresponding to two sides of the track. The roller has an arc surface. The coupling mechanism is provided with a first connecting member fixed to the counterweight. A second connecting member is mounted on the first connecting member and is telescopic relative to the first connecting member. One end of the second connecting member is provided with a pivot member. One end of the pivot member is formed with two arms corresponding to two sides of the rotating shaft. A pin is provided to penetrate the two arms and the rotating shaft. The first connecting member is provided with a slide rail thereon. A tail end of the first connecting member is provided with a third stopper. The second connecting member is provided with a second sliding seat. The second sliding seat is provided with at least one chute corresponding to the slide rail of the first connecting member.

According to the aforesaid technical feature, the motion carrier is provided with a wear-resistant structure corresponding to a rolling route of the at least one roller for reducing friction loss.

The wear-resistant structure of the motion carrier is formed of a wear-resistant material coated on a surface of the motion carrier.

The wear-resistant structure of the motion carrier is formed by polishing the surface of the motion carrier.

The recirculating gradient power system further comprises a base. The power cylinders are fixed to the base. The rotating shaft is pivotally disposed on the base. The motion carrier is mounted on the base through a universal coupling seat.

The recirculating gradient power system further comprises at least one fluid accumulator unit connected with the power cylinders.

The recirculating gradient power system further comprises at least one generator to constitute a transmission coupling in cooperation with the rotating shaft.

The recirculating gradient power system further comprises at least one fluid accumulator unit connected with the power cylinders and at least one generator to constitute a transmission coupling in cooperation with the rotating shaft.

The recirculating gradient power system further comprises a base and at least one fluid accumulator unit connected with the power cylinders. The power cylinders are fixed to the base. The rotating shaft is pivotally disposed on the base. The motion carrier is mounted on the base through a universal coupling seat.

The recirculating gradient power system further comprises a base and at least one generator to constitute a transmission coupling in cooperation with the rotating shaft. The power cylinders are fixed to the base. The rotating shaft is pivotally disposed on the base. The motion carrier is mounted on the base through a universal coupling seat.

The recirculating gradient power system further comprises a base, at least one fluid accumulator unit connected with the power cylinders, and at least one generator to constitute a transmission coupling in cooperation with the rotating shaft. The power cylinders are fixed to the base. The rotating shaft is pivotally disposed on the base. The motion carrier is mounted on the base through a universal coupling seat.

Preferably, the control module is provided with a plurality of valve elements connected with the power cylinders and a plurality of contact sensing elements corresponding to the rotating shaft, respectively.

Alternatively, the control module is provided with a plurality of valve elements connected with the power cylinders and a plurality of non-contact sensing elements corresponding to the rotating shaft, respectively.

More specifically, the circulating gradient power system of the prevent invention mainly uses the design of the motion carrier, the rotating shaft, the counterweight, the power cylinders, and the control module. Under the operation of the control module and all the power cylinders, the rotating shaft can be rotated continuously and stably by the output of intermittent fluid energy to achieve the purpose of using the kinetic energy more efficiently. In particular, the entire system is relatively less likely to produce heat during operation and does not exhaust any waste gas and does not make loud noises. The system can be mounted in any indoor space, not subject to external climate and environmental factors, meeting the needs of green energy.

### BRIEF DESCRIPTION OF THE DRAWINGS

FIG. 1 is a perspective view of the circulating gradient power system in accordance with a first embodiment of the present invention;

FIG. 2 is a front view of the circulating gradient power system in accordance with the first embodiment of the present invention;

FIG. 3 is a schematic view of the circulating gradient power system in accordance with the first embodiment of the present invention, showing the operating state of the left power cylinder;

FIG. 4 is a schematic view of the circulating gradient power system in accordance with the first embodiment of the present invention, showing the operating state of the front power cylinder;

FIG. 5 is a schematic view of the circulating gradient power system in accordance with the first embodiment of the present invention, showing the operating state of the right power cylinder;

FIG. 6 is a schematic view of the circulating gradient power system in accordance with the first embodiment of the present invention, showing the operating state of the rear power cylinder;

FIG. 7 is a perspective view of the circulating gradient power system in accordance with a second embodiment of the present invention;

FIG. 8 is a front view of the circulating gradient power system in accordance with the second embodiment of the present invention;

FIG. 9 is a perspective view of the circulating gradient power system in accordance with a third embodiment of the present invention;

FIG. 10 is a front view of the circulating gradient power system in accordance with the third embodiment of the present invention;

FIG. 11 is a schematic view showing the operation of the circulating gradient power system in accordance with the third embodiment of the present invention;

FIG. 12 is a perspective view of the circulating gradient power system in accordance with a fourth embodiment of the present invention; and

FIG. 13 is a front view of the circulating gradient power system in accordance with the fourth embodiment of the present invention.

### DESCRIPTION OF THE PREFERRED EMBODIMENTS

Embodiments of the present invention will now be described, by way of example only, with reference to the accompanying drawings.

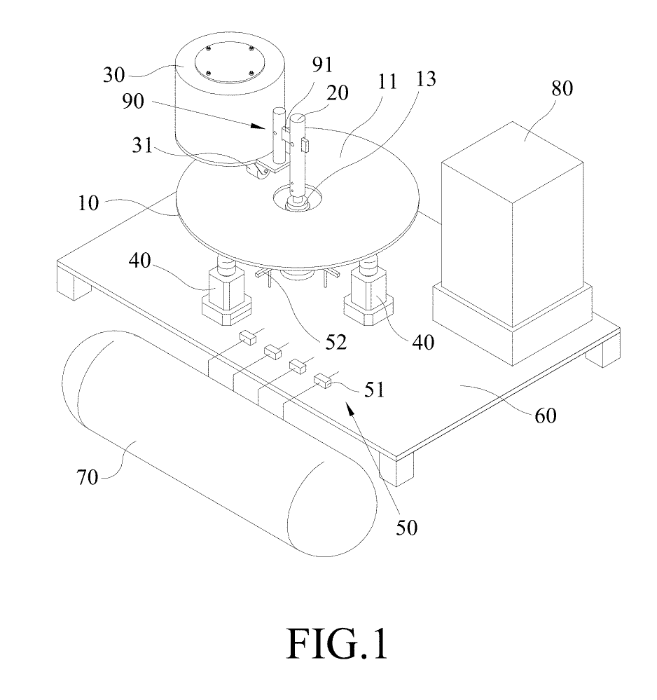

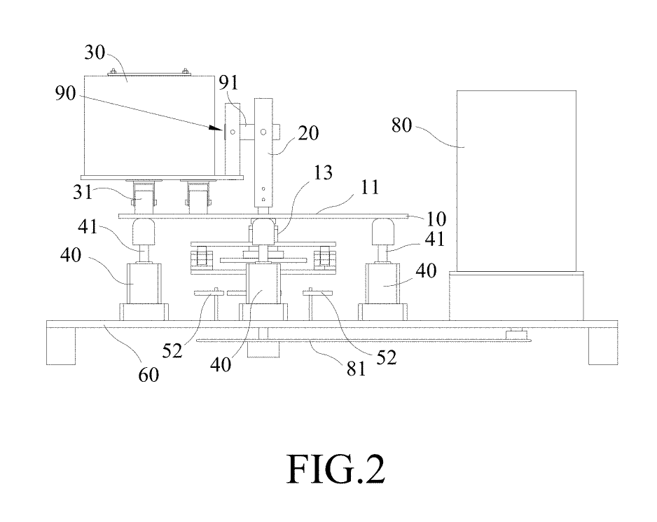

The present invention mainly provides a recirculating gradient power system capable of producing a continuous and stable rotational motion by the output of intermittent fluid energy. As shown in FIG. 1 and FIG. 2, the recirculating gradient power system of the present invention substantially comprises a motion carrier 10, a rotating shaft 20, a counterweight 30, at least four power cylinders 40, and a control module 50.

The motion carrier 10 is horizontally arranged and has a central vertical axis as a pivot to change its tilt orientation and tilt angle. In an embodiment, the motion carrier 10 may be a mechanical structure formed of a metal, a wood, plastics or a foam material by processing.

The rotating shaft 20 is vertically disposed at the position of the central vertical axis of the motion carrier 10.

The counterweight 30 is pivotally connected to the rotating shaft 20 through a coupling mechanism 90, and is rotationally displaced from the high point of the motion carrier 10 toward the lower point of the motion carrier 10 about the rotating shaft 20 by gravity to rotate the rotating shaft 20 synchronously. In an embodiment, the counterweight 30 is rotated through at least one roller 31 in contact with the motion carrier to roll on the motion carrier 10. In the present invention, the coupling mechanism 90 is used to connect the counterweight 30 and the rotating shaft 20. The coupling mechanism 90 may include an elbow member 91. Two ends of the elbow member 91 are pivotally connected to the rotating shaft 20 and the counterweight 30, respectively, i.e., the two ends of the elbow member 91 are respectively oscillated by the rotating shaft 20 and the counterweight 30, so that the roller 31 of the counterweight 30 can be kept in contact with the motion carrier 10 when the motion carrier 10 is tilted and oscillated.

As an example, the present invention comprises at least four power cylinders. The at least four power cylinders 40 are evenly arranged at four diagonal corners around the periphery of the central vertical axis of the motion carrier 10. In this embodiment, the recirculating gradient power system of the present invention comprises four power cylinders 40 located at four diagonal corners in the horizontal transverse direction and in the horizontal longitudinal direction around the periphery of the central vertical axis of the motion carrier 10, i.e., four diagonal corners at the front side, the rear side, the left side and the right side as shown in the drawings. Each of the power cylinders 40 is provided with a push rod 41 connected with a pressure source to drive the motion carrier 10 to change its tilt orientation and tilt angle.

The control module 50 is connected with the power cylinders 40 for controlling the operation of the power cylinders 40 which are set in advance when the counterweight 30 is rotationally displaced to a predetermined stroke. In an embodiment, the control module 50 may be provided with a plurality of valve elements 51 connected with the power cylinders 40 and a plurality of contact sensing elements 52 corresponding to the rotating shaft 20, respectively, or a plurality of non-contact sensing elements (not shown) corresponding to the rotating shaft 20, respectively. The contact sensing elements 52 or the non-contact sensing elements (not shown) are adapted to sense the displacement of the rotating shaft 20 and the counterweight 30 to transmit control signals to the respective valve members 51 which control the respective power cylinders 40. The control signals may be fluid signals such as electric current or airflow or liquid flow.

In this embodiment, the recirculating gradient power system further comprises a base 60. The power cylinders 40 are fixed to the base 60. The rotating shaft 20 is pivotally disposed on the base 60. The motion carrier 10 is mounted on the base 60 through a universal coupling seat 13.

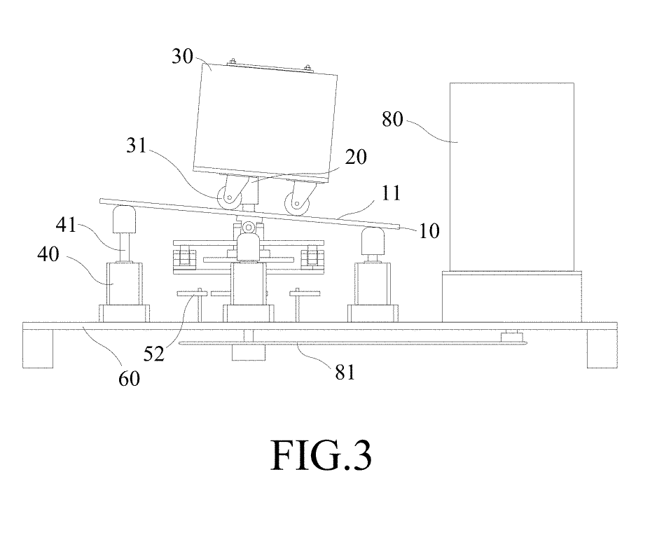

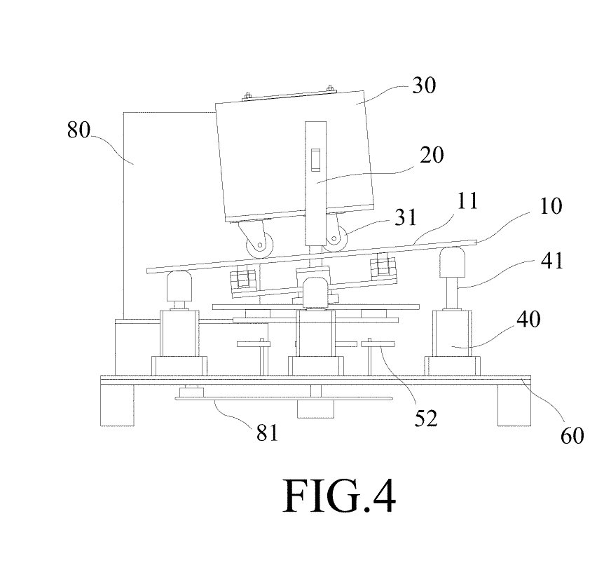

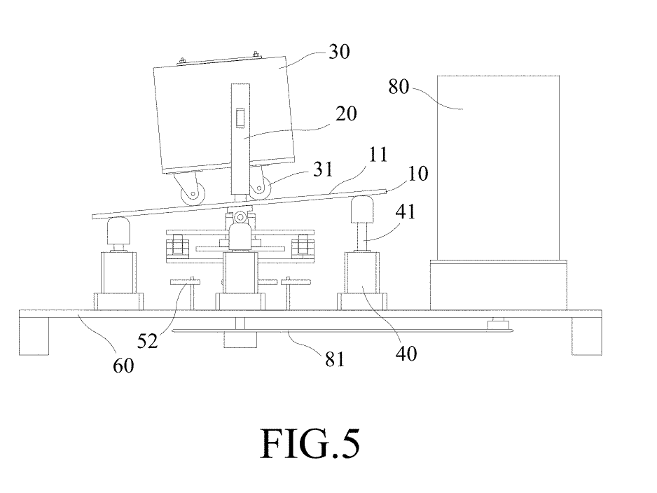

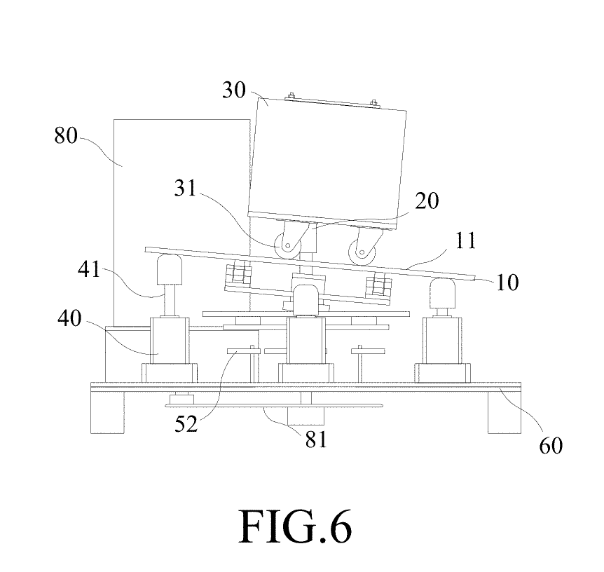

In principle, the recirculating gradient power system of the present invention allows the motion carrier 10 to continuously rotate in the direction of displacement of the counterweight 30 to change the tilt orientation by means of the fluid kinetic energy supplied from a fluid accumulator unit 70, such as an air compressor or a hydraulic device connected with the power cylinders 40, under the operation of the control module 50 and all the power cylinders 40, as shown in FIG. 3 to FIG. 6. Normally, the counterweight 30 is rotationally displaced from the high point of the motion carrier 10 toward the lower point of the motion carrier 10 by gravity.

Thereby, the rotating shaft 20 can be rotated continuously and stably by the intermittent fluid energy output from the power cylinders 40. In the practical application, the rotational motion of the rotating shaft 20 can be used to drive a generator 80 to run, so that the generator 80 can provide a continuous and stable power generation effect, achieving the purpose of using the kinetic energy more efficiently. In particular, the entire system is relatively less likely to produce heat during operation and does not exhaust any waste gas and does not make loud noises. The system can be mounted in any indoor space, not subject to external climate and environmental factors, meeting the needs of green energy.

As shown in FIG. 1 and FIG. 2, the recirculating gradient power system of the present invention, when implemented, may further comprise at least one generator 80 to constitute a transmission coupling in cooperation with the rotating shaft 20. The at least one generator 80 is connected with the rotating shaft 20 through a variable speed unit 81 to form a relatively more energy-saving and stable and reliable power supply.

Further, the recirculating gradient power system of the present invention may further comprise at least one fluid accumulator unit 70 connected to each of the power cylinders 40. The at least one fluid accumulator unit 70 is an air compressor or a hydraulic device. Preferably, the recirculating gradient power system may further comprise at least one generator 80 to constitute a transmission coupling in cooperation with the rotating shaft 20 and at least one fluid accumulator unit 70 connected to each of the power cylinders 40.

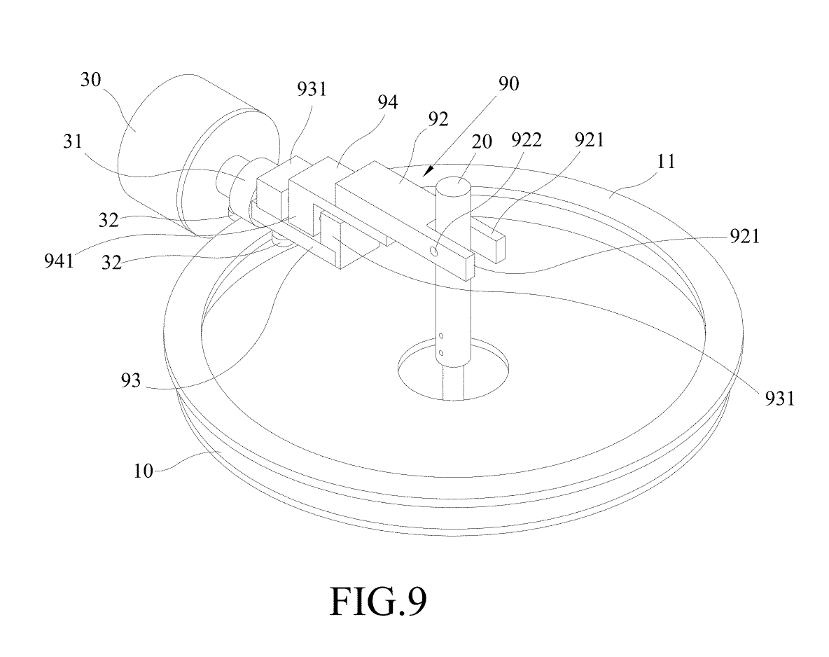

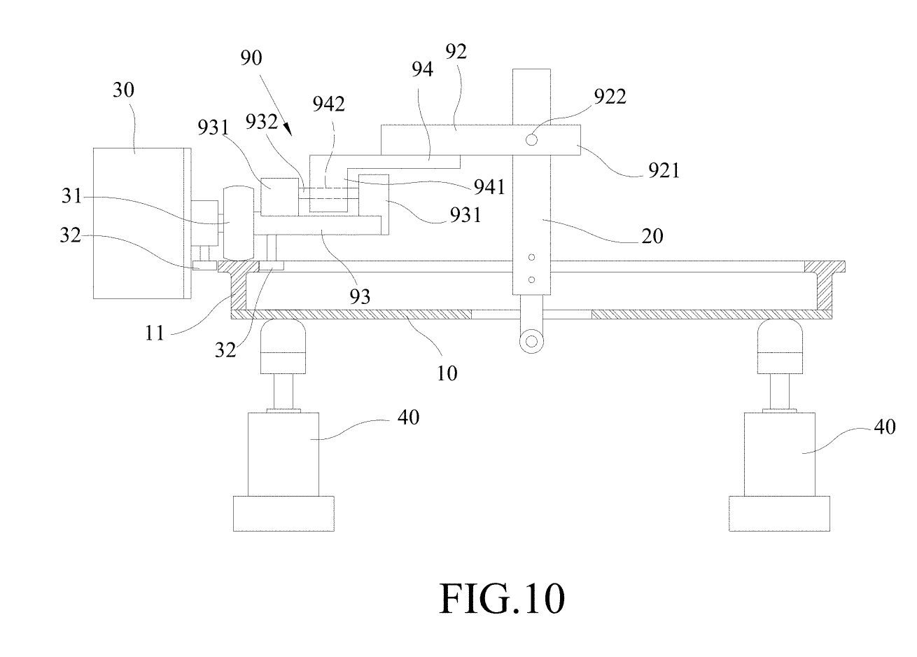

It is noted that the counterweight 30 of the recirculating gradient power system of the present invention is provided with at least one roller 31 in contact with the motion carrier 10 to maintain the smooth running and reduce the friction loss. Furthermore, as shown in FIG. 9 and FIG. 10, the motion carrier 10 may be provided with an annular track 11, and the counterweight 30 is provided with at least one roller 31 to roll on the track 11. The motion carrier 10 and the track 11 may be manufactured with different materials to reduce the material cost. Only the track 11 is replaced when the track 11 suffers a lot of wear and tear or is damaged.

Under the structure that the motion carrier 10 is provided with an annular track 11 and the counterweight 30 is provided with at least one roller 31 to roll on the track 11. The counterweight 30 may be provided with at least two auxiliary rollers 32 respectively corresponding to two sides of the track 11 to ensure that the roller 31 is surely rolled on the track 11.

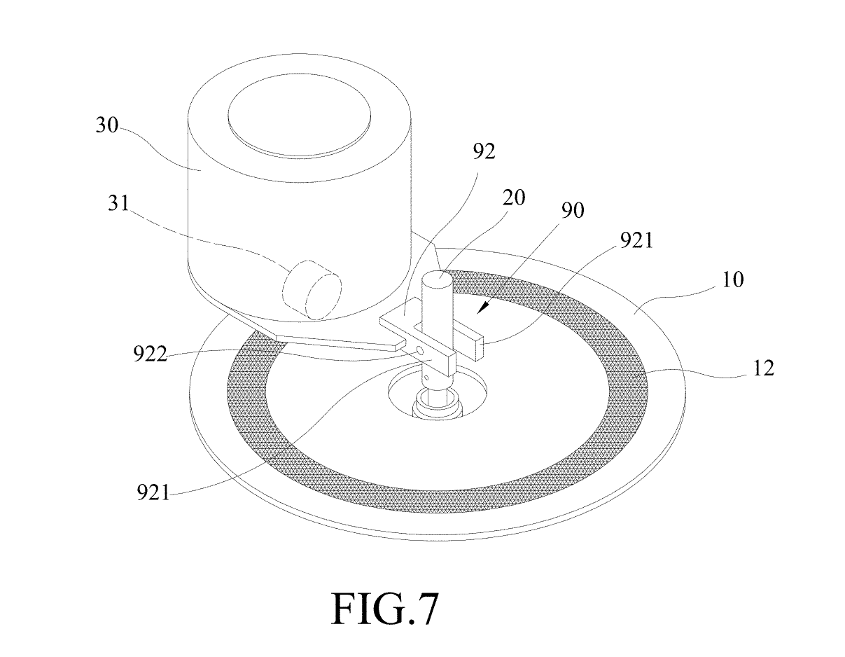

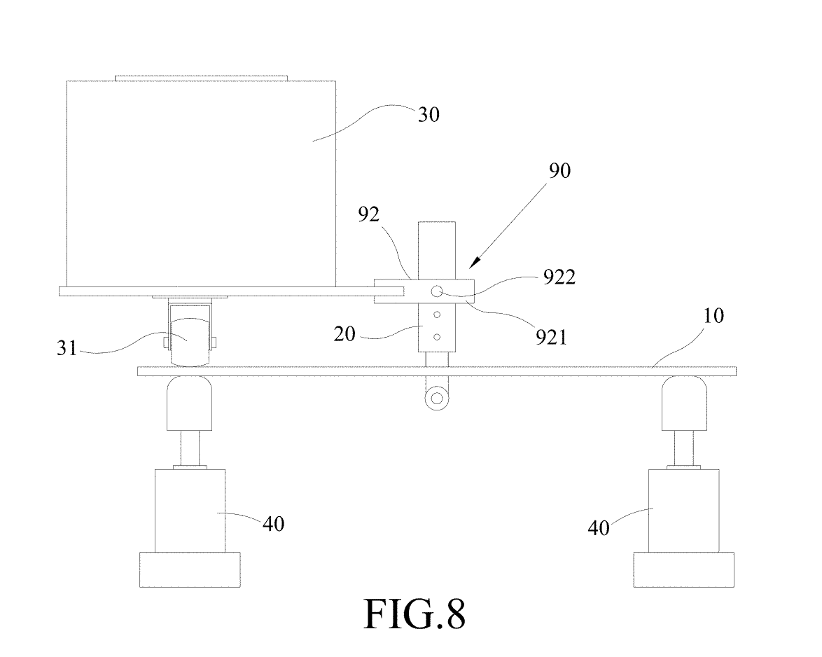

In addition, the coupling mechanism 90, as shown in FIG. 7 and FIG. 8, may be provided with a pivot member 92 fixed to the counterweight 30. One end of the pivot member 92 is formed with two arms 921 corresponding to two sides of the rotating shaft 20. A pin 922 is provided to penetrate the two arms 921 and the rotating shaft 20 so as to connect the counterweight 30 and the rotating shaft 20. This provides a pivot effect for the roller 31 of the counterweight 30 to get contact with the motion carrier 10 when the motion carrier 10 is tilted and oscillated.

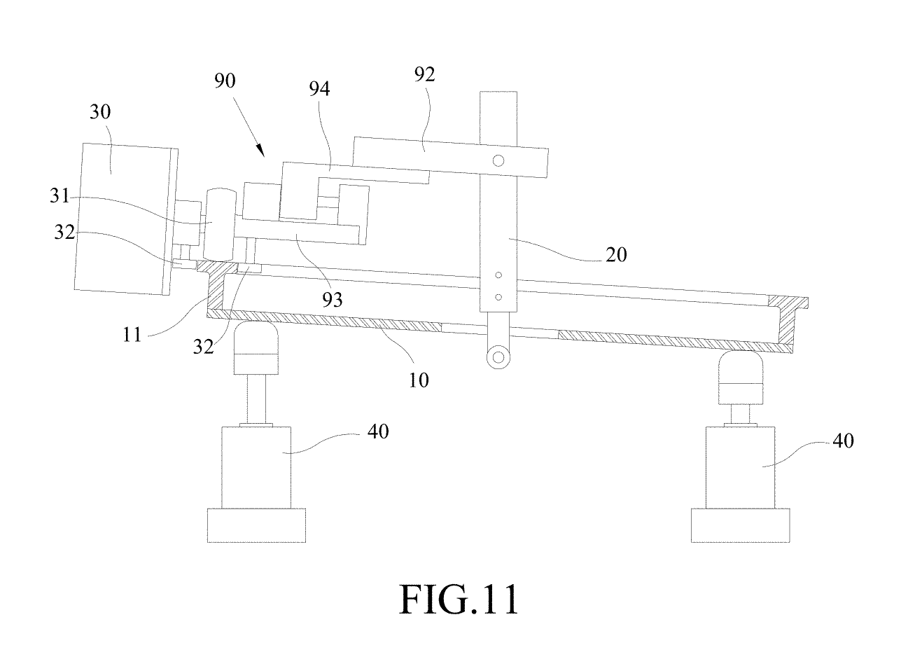

Furthermore, the coupling mechanism 90, as shown in FIG. 9 and FIG. 10, is provided with a first connecting member 93 fixed to the counterweight 30. A second connecting member 94 is mounted on the first connecting member 93 and is telescopic relative to the first connecting member 93. One end of the second connecting member 94 is provided with a pivot member 92. One end of the pivot member 92 is formed with two arms 921 corresponding to two sides of the rotating shaft 20. A pin 922 is provided to penetrate the two arms 921 and the rotating shaft 20. This provides a pivot effect for the roller 31 of the counterweight 30 to get contact with the motion carrier 10 when the motion carrier 10 is tilted and oscillated. Furthermore, the second connecting member 94 is telescopic relative to the first connecting member 93 (as shown in FIG. 10 and FIG. 11) to prevent the roller 31 of the counterweight 30 from slipping, thereby greatly reducing the wear and the friction loss of the roller 31.

According to the aforesaid embodiments of the recirculating gradient power system of the present invention, the recirculating gradient power system can be presented as the following implementations:

In the embodiment shown in FIG. 1 and FIG. 2, the counterweight 30 is disposed at a position where the center of mass of the counterweight 30 is located above the motion carrier 10. The counterweight 30 is provided with four rollers 31 in contact with the motion carrier 10 to roll on the motion carrier 10. The coupling mechanism 90 is provided with an elbow member 91. Two ends of the elbow member 91 are pivotally connected to the rotating shaft 20 and the counterweight 30, respectively.

In the embodiment shown in FIG. 7 and FIG. 8, the counterweight 30 is disposed at a position where the center of mass of the counterweight 30 is located above the motion carrier 10. The counterweight 30 is provided with a roller 31 in contact with the motion carrier 10 to roll on the motion carrier 10. The roller 31 has an arc surface. The coupling mechanism 90 is provided with a pivot member 92 fixed to the counterweight 30. One end of the pivot member 92 is formed with two arms 921 corresponding to two sides of the rotating shaft 20. A pin 922 is provided to penetrate the two arms 921 and the rotating shaft 20.

In the embodiment shown in FIG. 9 and FIG. 11, the counterweight 30 is disposed at a position where the center of mass of the counterweight 30 is located at an outer side of the motion carrier 10. The motion carrier 10 is provided with an annular track 11. The counterweight 30 is provided with a roller 31 to roll on the track 11. The counterweight 30 is provided with at least two auxiliary rollers 32 respectively corresponding to two sides of the track 11. The roller 31 has an arc surface. The coupling mechanism 90 is provided with a first connecting member 93 fixed to the counterweight 30. A second connecting member 94 is mounted on the first connecting member 93 and is telescopic relative to the first connecting member 93. One end of the second connecting member 94 is provided with a pivot member 92. One end of the pivot member 92 is formed with two arms 921 corresponding to two sides of the rotating shaft 20. A pin 922 is provided to penetrate the two arms 921 and the rotating shaft 20. The first connecting member 93 is provided with two first stoppers 931 thereon. At least one guide post 932 is provided between the two first stoppers 931. The second connecting member 94 is provided with a first sliding seat 941 inserted between the two first stoppers 931. The first sliding seat 941 is provided with at least one guide hole 942 for the guide post 932 of the first connecting member 93 to insert therethrough.

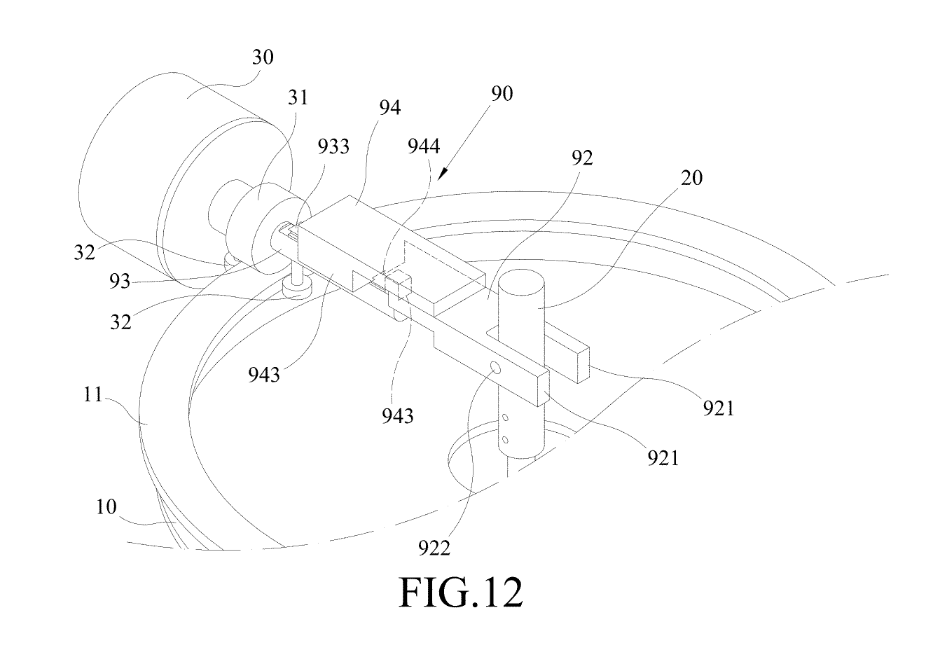

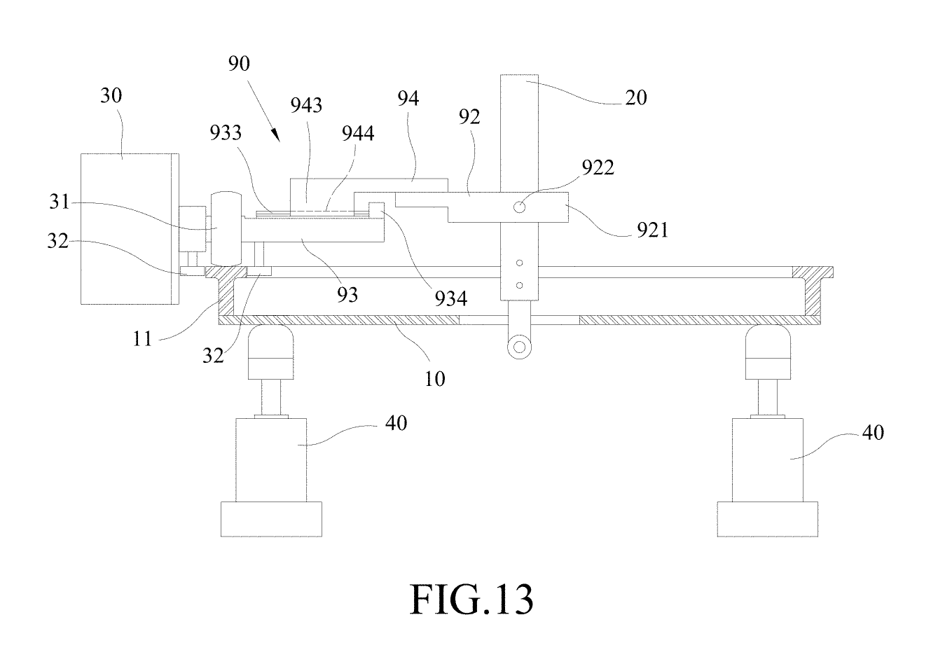

In the embodiment shown in FIG. 12 and FIG. 13, the counterweight 30 is disposed at a position where the center of mass of the counterweight 30 is located at an outer side of the motion carrier 10. The motion carrier 10 is provided with an annular track 11. The counterweight 30 is provided with a roller 31 for rolling on the track 11. The counterweight 30 is provided with at least two auxiliary rollers 32 respectively corresponding to two sides of the track 11. The roller 31 has an arc surface. The coupling mechanism 90 is provided with a first connecting member 93 fixed to the counterweight 30. A second connecting member 94 is mounted on the first connecting member 93 and is telescopic relative to the first connecting member 93. One end of the second connecting member 94 is provided with a pivot member 92. One end of the pivot member 92 is formed with two arms 921 corresponding to two sides of the rotating shaft 20. A pin 922 is provided to penetrate the two arms 921 and the rotating shaft 20. The first connecting member 93 is provided with a slide rail 933 thereon. A tail end of the first connecting member 93 is provided with a third stopper 934. The second connecting member 94 is provided with a second sliding seat 943. The second sliding seat 943 is provided with at least one chute 944 corresponding to the slide rail 933 of the first connecting member 93.

In the different embodiments shown in FIG. 7 to FIG. 13, the surface of the roller 31 is designed in an arc shape as a connecting line from the counterweight 30 to the pivot point of the rotating shaft 20 when the motion carrier 10 is tilted and oscillated. When the included angle between the counterweight 30 and the axis of the motion carrier 10 is changed, the contact point between the roller 31 and the motion carrier 10 is smoothly changed from the inner side of the roller 31 to the outer side of the roller 31 or from the outer side of the roller 31 to the inner side of the roller 31 so as to prevent the counterweight 30 from vibrating or jumping, thereby maintaining the smoothness and stability of the operation.

In the respective embodiments shown in FIG. 9 to FIG. 13, the center of mass of the counterweight 30 is located at an outer side of the motion carrier 10, and even the center of mass of the counterweight 30 is kept at the connecting line from the counterweight 30 to the pivot point of the rotating shat 20 so as to prevent the counterweight 30 from being tilted forward or rearward. This way not only maintains the smoothness and stability of running but also reduce the number of the rollers 31. The present invention is beneficial to reduce equipment costs, running noises and the loss of thermal energy.

In the circulating gradient power system of the present invention, the roller 31 of the counterweight 30 of the embodiments shown in FIG. 1 to FIG. 6 or FIG. 7 and FIG. 8 is in contact with the motion carrier 10. The motion carrier 10, as shown in FIG. 7 and FIG. 8, may be provided with a wear-resistant structure 12 corresponding to the rolling route of the roller 31 to reduce friction loss. In an embodiment, the wear-resistant structure 12 of the motion carrier 10 may be formed of a wear-resistant material coated on the surface of the motion carrier 10, or the surface of the motion carrier 10 is treated with a polishing process, such that the service life of the motion carrier 10 can be improved in addition to the reduction of the running noise and the loss of thermal energy.

Compared with the prior art, the circulating gradient power system of the prevent invention mainly uses the design of the motion carrier, the rotating shaft, the counterweight, the power cylinders, and the control module. Under the operation of the control module and all the power cylinders, the rotating shaft can be rotated continuously and stably by the output of intermittent fluid energy, achieving the purpose of using the kinetic energy more efficiently. In particular, the entire system is relatively less likely to produce heat during operation and does not exhaust any waste gas and does not make loud noises. The system can be mounted in any indoor space, not subject to external climate and environmental factors, meeting the needs of green energy.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A recirculating gradient power system, comprising:
a motion carrier, horizontally arranged, having a central vertical axis as a pivot to change its tilt orientation and tilt angle;
a rotating shaft, vertically disposed at the position of the central vertical axis of the motion carrier;
a counterweight, pivotally connected to the rotating shaft through a coupling mechanism, the counterweight being rotationally displaced from a high point of the motion carrier toward a lower point of the motion carrier about the rotating shaft by gravity to rotate the rotating shaft synchronously, the counterweight being provided with at least one roller in contact with the motion carrier to roll on the motion carrier, the coupling mechanism including an elbow member, two ends of the elbow member being pivotally connected to the rotating shaft and the counterweight respectively;
at least four power cylinders, evenly arranged at four diagonal corners around the periphery of the central vertical axis of the motion carrier, each of the power cylinders being provided with a push rod connected with a pressure source to drive the motion carrier to change the tilt orientation and the tilt angle;
a control module, connected with the power cylinders for controlling the operation of the power cylinders which are set in advance when the counterweight is rotationally displaced to a predetermined stroke.

2. The recirculating gradient power system as claimed in claim 1, wherein the motion carrier is provided with an annular track, and the at least one roller of the counterweight is in contact with the track to roll on the track.

3. The recirculating gradient power system as claimed in claim 1, wherein the motion carrier is provided with an annular track, the at least one roller of the counterweight is in contact with the track to roll on the track, and the counterweight is provided with at least two auxiliary rollers respectively corresponding to two sides of the track.

4. The recirculating gradient power system as claimed in claim 1, wherein the coupling mechanism is provided with a pivot member fixed to the counterweight, one end of the pivot member is formed with two arms corresponding to two sides of the rotating shaft, and a pin is provided to penetrate the two arms and the rotating shaft.

5. The recirculating gradient power system as claimed in claim 1, wherein the coupling mechanism is provided with a first connecting member fixed to the counterweight, a second connecting member is mounted on the first connecting member and is telescopic relative to the first connecting member, one end of the second connecting member is provided with a pivot member, one end of the pivot member is formed with two arms corresponding to two sides of the rotating shaft, and a pin is provided to penetrate the two arms and the rotating shaft.

6. The recirculating gradient power system as claimed in claim 1, wherein the counterweight is disposed at a position where the center of mass of the counterweight is located above the motion carrier; the counterweight is provided with four rollers in contact with the motion carrier to roll on the motion carrier; the coupling mechanism is provided with an elbow member, and two ends of the elbow member are pivotally connected to the rotating shaft and the counterweight, respectively.

7. The recirculating gradient power system as claimed in claim 1, wherein the counterweight is disposed at a position where the center of mass of the counterweight is located above the motion carrier; the at least one roller of the counterweight is in contact with the motion carrier to roll on the motion carrier, the roller has an arc surface; the coupling mechanism is provided with a pivot member fixed to the counterweight, one end of the pivot member is formed with two arms corresponding to two sides of the rotating shaft, and a pin is provided to penetrate the two arms and the rotating shaft.

8. The recirculating gradient power system as claimed in claim 1, wherein the counterweight is disposed at a position where the center of mass of the counterweight is located at an outer side of the motion carrier; the motion carrier is provided with an annular track, the at least one roller of the counterweight is in contact with the track to roll on the track, the counterweight is provided with at least two auxiliary rollers respectively corresponding to two sides of the track, the roller has an arc surface; the coupling mechanism is provided with a first connecting member fixed to the counterweight, a second connecting member is mounted on the first connecting member and is telescopic relative to the first connecting member, one end of the second connecting member is provided with a pivot member, one end of the pivot member is formed with two arms corresponding to two sides of the rotating shaft, a pin is provided to penetrate the two arms and the rotating shaft; the first connecting member is provided with two first stoppers thereon, at least one guide post is provided between the two first stoppers; the second connecting member is provided with a first sliding seat inserted between the two first stoppers, and the first sliding seat is provided with at least one guide hole for the guide post of the first connecting member to insert therethrough.

9. The recirculating gradient power system as claimed in claim 1, wherein the counterweight is disposed at a position where the center of mass of the counterweight is located at an outer side of the motion carrier; the motion carrier is provided with an annular track, the at least one roller of the counterweight is in contact with the track to roll on the track, the counterweight is provided with at least two auxiliary rollers respectively corresponding to two sides of the track, the roller has an arc surface; the coupling mechanism is provided with a first connecting member fixed to the counterweight, a second connecting member is mounted on the first connecting member and is telescopic relative to the first connecting member, one end of the second connecting member is provided with a pivot member, one end of the pivot member is formed with two arms corresponding to two sides of the rotating shaft, a pin is provided to penetrate the two arms and the rotating shaft; the first connecting member is provided with a slide rail thereon, a tail end of the first connecting member is provided with a third stopper; the second connecting member is provided with a second sliding seat, and the second sliding seat is provided with at least one chute corresponding to the slide rail of the first connecting member.

10. The recirculating gradient power system as claimed in claim 2, wherein the motion carrier is provided with a wear-resistant structure corresponding to a rolling route of the at least one roller for reducing friction loss, the wear-resistant structure is formed of a wear-resistant material coated on a surface of the motion carrier, or the surface of the motion carrier is treated with a polishing process.

11. The recirculating gradient power system as claimed in claim 1, further comprising a base, the power cylinders being fixed to the base, the rotating shaft being pivotally disposed on the base, the motion carrier being mounted on the base through a universal coupling seat.

12. The recirculating gradient power system as claimed in claim 1, further comprising at least one fluid accumulator unit connected with the power cylinders.

13. The recirculating gradient power system as claimed in claim 1, further comprising at least one generator to constitute a transmission coupling in cooperation with the rotating shaft.

14. The recirculating gradient power system as claimed in claim 1, further comprising at least one fluid accumulator unit connected with the power cylinders and at least one generator to constitute a transmission coupling in cooperation with the rotating shaft.

15. The recirculating gradient power system as claimed in claim 1, further comprising a base and at least one fluid accumulator unit connected with the power cylinders; the power cylinders being fixed to the base, the rotating shaft being pivotally disposed on the base, the motion carrier being mounted on the base through a universal coupling seat.

16. The recirculating gradient power system as claimed in claim 1, further comprising a base and at least one generator to constitute a transmission coupling in cooperation with the rotating shaft; the power cylinders being fixed to the base, the rotating shaft being pivotally disposed on the base, the motion carrier being mounted on the base through a universal coupling seat.

17. The recirculating gradient power system as claimed in claim 1, further comprising a base, at least one fluid accumulator unit connected with the power cylinders, and at least one generator to constitute a transmission coupling in cooperation with the rotating shaft; the power cylinders being fixed to the base, the rotating shaft being pivotally disposed on the base, the motion carrier being mounted on the base through a universal coupling seat.

18. The recirculating gradient power system as claimed in claim 1, wherein the control module is provided with a plurality of valve elements connected with the power cylinders and a plurality of contact sensing elements corresponding to the rotating shaft, respectively.

19. The recirculating gradient power system as claimed in claim 1, wherein the control module is provided with a plurality of valve elements connected with the power cylinders and a plurality of non-contact sensing elements corresponding to the rotating shaft, respectively.

20. A recirculating gradient power system, comprising:
a motion carrier, horizontally arranged, having a central vertical axis as a pivot to change its tilt orientation and tilt angle;
a rotating shaft, vertically disposed at the position of the central vertical axis of the motion carrier;
a counterweight, pivotally connected to the rotating shaft through a coupling mechanism, the counterweight being rotationally displaced from a high point of the motion carrier toward a lower point of the motion carrier about the rotating shaft by gravity to rotate the rotating shaft synchronously;
a plurality of power cylinders, evenly arranged at diagonal corners around the periphery of the central vertical axis of the motion carrier, each of the power cylinders being provided with a push rod connected with a pressure source to drive the motion carrier to change the tilt orientation and the tilt angle;
a control module, connected with the power cylinders for controlling the operation of the power cylinders which are set in advance when the counterweight is rotationally displaced to a predetermined stroke.
